(19) United States
(12) Patent Application Publication
(10) Pub. No.: US 2009/0237925 A1
(43) Pub. Date: Sep. 24, 2009

(54) White-light light-emitting diode (LED) road lamp composed of red, green and blue leds

(76) Inventors: Yeh-Chin Chao, Hsinchu City (TW); Hongqiu Deng, Tianjin (CN); Lianshan Li, Tianjin (CN)

Correspondence Address: TROXELL LAW OFFICE PLLC, SUITE 1404, 5205 LEESBURG PIKE, FALLS CHURCH, VA, 22041, US

(21) Appl. No.: 12/076,447

(22) Filed: Mar. 18, 2008

(51) Int. Cl. F21V 9/00; F21V 29/00

(52) U.S. Cl. 362/231; 362/294

(57) ABSTRACT

The invention provides a white-light LED road lamp composed of red, green, and blue LED's. The road lamp includes a road lamp body, a heat-dissipating element, a constant-current source, and an LED board. The road lamp body is suspended at a specific height above the ground. Inside the road lamp body is disposed with the LED board connected with the heat-dissipating element. The side surface of the LED board opposite to the heat-dissipating element is electrically connected with a plurality of red, green, and blue LED's. The LED's are connected in series or parallel and driven by the constant-current source.

### BACKGROUND OF THE INVENTION

1. Field of Invention

The invention relates to a road lamp and, in particular, to a white-light LED lamp composed of red, green, and blue LED's.

2. Related Art

Road construction speed and quality grow rapidly with the development of modernized metropolitans. To ensure the security in traffic at night, road lamps are often provided on both sides of roads. Due to tremendous progress in semiconductor technology, current LED illumination has the ability to replace traditional illumination devices. Using LED for illumination has the advantages of high stability, no flashing, more colors, good color quality, and ease in controls. As the LED is a point light source, its illumination orientation can be readily adjusted. Therefore, using a light source with a specific lighting orientation for illumination can make better use of the optical energy emitted thereby. A smaller power is needed to achieve local-area illumination than the prior art. Therefore, a lot of energy can be saved.

Currently, most road lamps use high-pressure sodium light, various kinds of fluorescent lamps, or incandescent lamps. Their light-emitting efficiencies are only about 30%. The rest of electrical energy is converted into waste heat. Therefore, there is a higher demand for using the LED's in road lamps to save energy. The LED lamp has the features of high light-emitting efficiency, low power consumption, quick reaction speed, long lifetime, high security, and environment-friendly. They thus have a great potential to become substitute illumination devices on the market.

However, current LED lamps all use white-light LED as the light sources. To satisfy the need of high luminosity, they generally use high-power white-light LED (1 W or 2 W) as the light sources. The light-emitting principle of white-light LED's is to use a blue-light chip with fluorescent powders thereon. The brightness of blue-light chips is comparatively lower than LED chips of other colors. Moreover, the fluorescent powders have a large attenuation. Therefore, the white-light LED has a larger attenuation in brightness as well. As a result, the heat generated by such a high-power LED is more than ordinary LED's.

### SUMMARY OF THE INVENTION

In view of the foregoing, it is an objective of the invention to provide a white-light LED road lamp composed of red, green, and blue LED's. By using high-luminosity red, green, and blue LED's to synthesize white or warm white light, the lifetime of the invention is longer than the high-power white-light LED's. As the red, green, and blue LED's have better light-emitting efficiencies, the brightness provided by the invention is 1.5 to 3 times better than the white-light LED's under the same power and other conditions. This invention thus effectively solves the problem of large attenuation and heat production in the white-light LED's. It has a good energy-saving effect and longer lifetime. Moreover, the invention provides more colors because it uses the red, green, and blue LED's as the components of its light source.

To achieve the above-mentioned objective, the invention includes a road lamp body, a heat-dissipating element, a constant-current source, and an LED board.

The road lamp body is suspended at a specific height above the ground. The bottom of the road lamp body is provided with the constant-current source to provide a stable electrical current. A feature of the invention is that the LED board connected with the heat-dissipating element is disposed inside the road lamp body opposite to its opening. One side surface of the LED board opposite to the heat-dissipating element is electrically connected with a plurality of red, green, and blue LED's. Each of the red, green, and blue LED's is connected in parallel to in series and driven by the constant-current source.

### BRIEF DESCRIPTION OF THE DRAWINGS

FIG. 1 is a schematic three-dimensional view of the invention; and

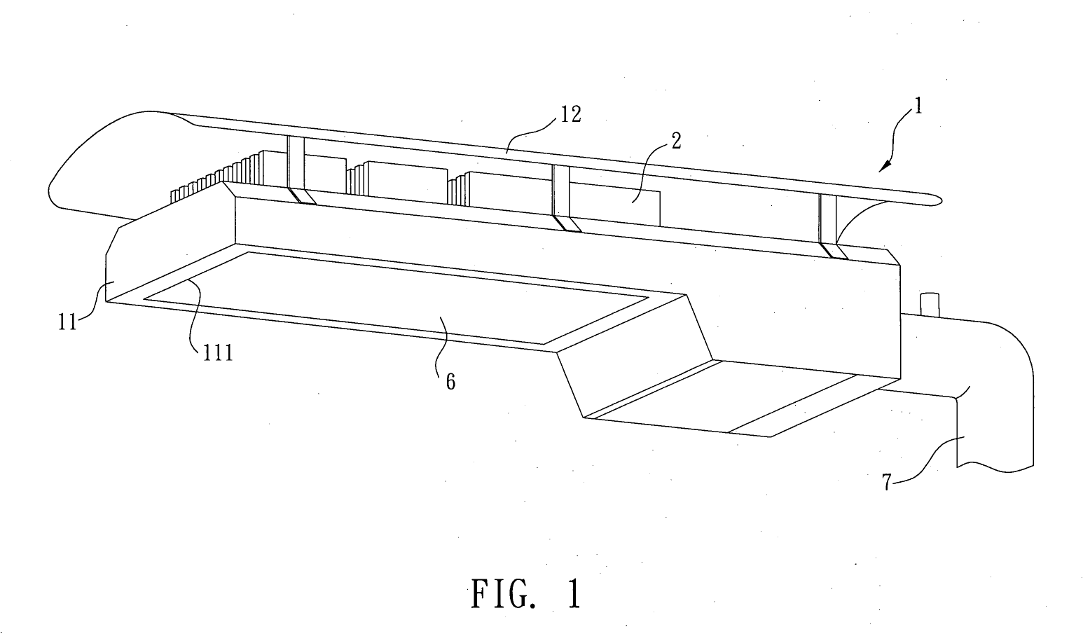

FIG. 2 is a schematic view showing the structure in a planar cross section of the invention.

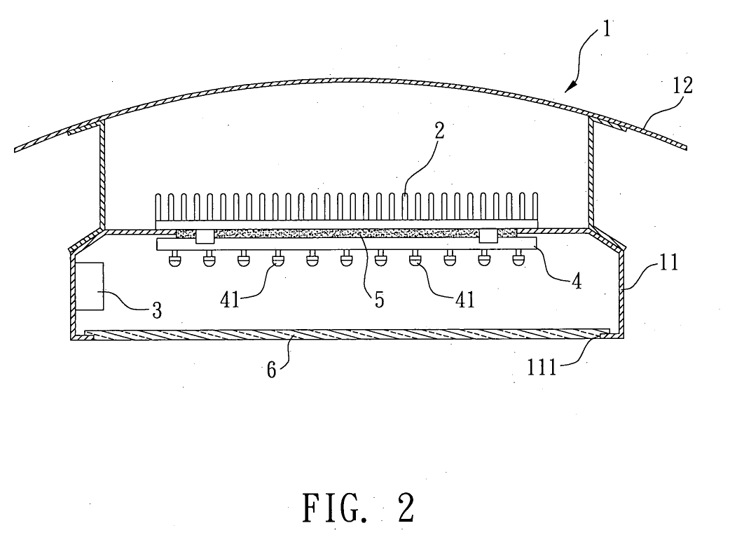

### DETAILED DESCRIPTION OF THE INVENTION

The present invention will be apparent from the following detailed description, which proceeds with reference to the accompanying drawings, wherein the same references relate to the same elements.

The preferred embodiment of the invention provides a white-light road lamp composed of red, green, and blue LED's. The road lamp includes a road lamp body 1, a heat-dissipating element 2, a constant-current source 3, and an LED board 4.

The road lamp body 1 is suspended at a specific height above the ground. The bottom of the road lamp body 1 facing the road has an opening 111. The heat-dissipating element 2 is disposed in the road lamp body 1, corresponding to the opening 111. The constant-current source 3 is disposed in the road lamp body 1 to provide a stable electrical current. A feature of the invention is that the LED board 4 connected with the heat-dissipating element 2 is disposed inside the road lamp body 1, opposite to its opening 111. One side surface of the LED board 4 opposite to the heat-dissipating element 2 is electrically connected with a plurality of red, green, and blue LED's 41. Each of the red, green, and blue LED's 41 is connected in parallel to in series and driven by the constant-current source 3.

In this embodiment, the road lamp body 1 further has a lamp shell 11 and a lamp shade 12. The lamp shell 11 is suspended at a specific height above the ground by a lamp post 7. The bottom of the lamp shell 11 corresponding to the road is formed with the opening 111. The constant-current source 3 and the LED board 4 are disposed in the lamp shell 11. The LED's 41 on the LED board 4 correspond to the opening 111. The heat-dissipating element 2 is disposed on the outer side of the lamp shell 11 and corresponding to the LED board 4. On the side surface of the LED board 4 opposite to the LED's 41 is covered with ointment-like heat-conductive silicon resin and soft heat-conductive silicon film 5 connecting to the heat-dissipating element 2. Each of the LED's 41 is electrically connected with the LED board 4 by soldering. A lamp shade 12 is disposed above the heat-dissipating element 2. A piece of sand-blasted glass 6 is disposed at the opening 111 of the lamp shell 11.

The red, green, and blue LED's on the LED board 4 are evenly distributed. The red LED emits light of wavelength between 610 nm and 640 nm. The green LED emits light of wavelength between 510 nm and 540 nm. The blue LED emits light of wavelength between 450 nm and 480 nm. According to the wavelengths and currents of the LED's with different colors, the brightness of them is adjusted to produce white or warm white light. The ratio of individual colors fall in the range 2⁻4:5⁻7:0.5⁻2. In a preferred embodiment, the brightness ratio among the red, green, and blue light is 3:6:1.

All the LED's are driven by the constant-current source. Therefore, they provide homogeneous illumination without flashing, as required. Their lifetime is longer than the LED's in the conventional LED road lamp. For the illumination of roads, the disclosed LED is equipped with a lens that has an elliptical light-emitting surface so as to produce an elliptical light shape. For such an LED light source of power 80 W, its central luminosity at 10 meters away is greater than 42 Lux. The light covers an elliptical area, very suitable for road illumination.

Since the LED board is connected with the heat-dissipating element via the ointment-like heat-conductive silicon resin and the soft heat-conductive silicon film, the heat produced by the LED's can be easily removed. The sand-blasted glass is utilized to perform a second color mixing, so that the homogeneity of emitted light is better.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A light-emitting diode (LED) road lamp that synthesizes white light using red, green, and blue LED's, the road lamp comprising:
a road lamp body, which is suspended at a specific height above the ground and has an opening formed at the bottom thereof corresponding to the road;
a heat-dissipating element, which is disposed in the road lamp body corresponding to the opening;
a constant-current source, which s disposed in the road lamp body to provide a stable electrical current; and
an LED board;
wherein the LED board is disposed opposite to the opening and connected with the heat-dissipating element, the LED board is electrically connected with a plurality of red, green, and blue LED's on the side opposite to the heat-dissipating element, and the red, green, and blue LED's are connected in series or parallel and driven by the constant-current source.

2. The LED road lamp of claim 1, wherein the red, green, and blue LED's are evenly distributed on the LED board.

3. The LED road lamp of claim 1, wherein the red LED emits light of wavelength between 610 nm and 640 nm, the green LED emits light of wavelength between 510 nm and 540 nm, and the blue LED emits light of wavelength between 450 nm and 480 nm.

4. The LED road lamp of claim 1, wherein the ratio in the brightness of the red, green, and blue LED's on the LED board falls in the range 2⁻4:5⁻7:0.5⁻2.

5. The LED road lamp of claim 1, wherein the illuminated light shape of the red, green, and blue LED's is elliptical.

6. The LED road lamp of claim 1, wherein the road lamp body further includes a lamp shell and a lamp shade; wherein the lamp shell is suspended by a lamp post at a specific height above the ground, the opening is formed at the bottom of the lamp shell corresponding to the road, the constant-current source and the LED board are disposed in the lamp shell in a way such that the LED's correspond to the opening, and the heat-dissipating element is disposed on the outer side of the lamp shell corresponding to the LED board.

7. The LED road lamp of claim 6, wherein the side of the LED board opposite to the LED's is covered with ointment-like heat-conductive silicon resin and a soft heat-conductive silicon film connected with the heat-dissipating element.

8. The LED road lamp of claim 6, wherein a piece of sand-blasted glass is disposed at the opening of the lamp shell.
